(19) United States
(12) Patent Application Publication
(10) Pub. No.: US 2026/0069391 A1
(43) Pub. Date: Mar. 12, 2026

(54) Animal Restraint

(71) Applicant: DrMarkInnovations.Vet LLC, Victoria, TX (US)

(72) Inventor: Mark Besancon, Victoria, TX (US)

(21) Appl. No.: 18/826,731

(22) Filed: Sep. 6, 2024

(51) Int. Cl. A61D 3/00

(52) U.S. Cl. CPC A61D 3/00

(57) ABSTRACT

An enclosure to restrain animals humanely prior to performing procedure on them. The enclosure comprises a rear wall, base with a lip or protrusion, and a front wall or gate. The rear wall is fixed to a surface such as a wall or partition. The front wall or gate is hingedly attached to the lip or protrusion and releasably fixed with the rear wall. There is a guide cleat mechanism to secure and unsecure the front wall or gate so that it opens away from the rear wall at an angle to receive animals in the enclosure. Once the animal is in the enclosure, the front wall or gate can be secured and procedure conducted on the animal through the openings on the fabric gate cover that wraps around the frame of the front wall or gate.

### FIELD OF THE INVENTION

The present invention, in general, relates to an animal restraint device designed to humanely and temporarily restrain animals, including but not limited to small to medium sized animals, but inclusive also of larger breeds, in veterinary and pet facilities. Specifically, this unique single-stage pivot device comprises a back plate that can be fixed to a solid support via securing mechanisms. Attached to this plate is a framed fabric swing gate for the restraint of animals (e.g., canines) when an animal walks, or is led, into the area enclosed between the fixed back plate and the swing gate. Additionally, the swing gate has openings to allow access to the parts of the animal that need attention when performing procedures.

### BACKGROUND

Veterinarians and other service providers of animals generally face a problem in restraining animals humanely when performing procedures, such as routine exams, treatments, injections, grooming and nail trims. Pets that usually are calm and obedient when walking on a leash suddenly become aggressive and spastic when they are in pet hospitals or clinics, grooming salons, and pet boarding facilities where animals need to be restrained for performing these procedures. In many cases, these scared animals have inflicted multiple bite wounds and scratches on the human restrainers and many times, such facilities resort to sedating animals prior to the procedure which comes with its own risks, up to and including death.

While there are devices for restraining big-sized animals, these devices may not be effective in restraining small or medium sized animals for reasons including but not limited to the fact that the pressure required to restrain a larger animal is quite different from the pressure used to restrain a smaller or medium sized animal. In other words, the pressure to restrain or the materials used in the construction of the devices to restrain larger-sized animals may not be humane or comforting to smaller or medium sized animals and may even end up hurting smaller sized animals. Additionally, the pain or discomfort experienced by the small or medium sized animal may further aggravate the animal to such an extent that it may make it much more fearful and aggressive in its present and any subsequent visit to the facility. For instance, pet salons use a leash to restrain animals while bathing, trimming or haircut. Clearly, the animals experience discomfort and fear when the technician is performing these procedures as it is held by a leash wherein it is often the case that, as an animal struggles, retraining leashes become more restrictive and tighter thus exacerbating the animal's fear, apprehension and anxiety.

Sedation of animals before a procedure may seem like a better alternative to restraining animals physically. However, this technique also requires restraining the animal while injecting a chemical in its body. Additionally, on top of the rare but serious potential life-threatening consequences of sedation, the time spent in administering the sedative and waking the animal after the procedure prolongs the time required for and overall cost of a procedure. Hence, there is a need for a safe, quick, non-sedating, and effective restraint device ranging from smaller-sized animals to larger animals that will not only allow for humanely restraining these animals but also have features to allow veterinarians and other service providers to easily perform the procedures while the animal is restrained.

While the inventor has set forth the best mode or modes contemplated in carrying out the present invention known to the inventor, such as to enable a person skilled in the art to make and practice the present invention, the preferred embodiments are, however, not intended to be limiting, but are, on the contrary, included in a non-limiting sense apt to amendments, alterations, alternatives and modifications, based primarily on the animal size, in light of specification and appended claims forming the current disclosure.

### BRIEF SUMMARY OF THE INVENTION

An enclosure to humanely restrain animals is provided herein, wherein the enclosure comprises a secured rear wall plate that is affixed to a wall or a stable surface, a base, and an elastic, meshed material with openings, secured to a framed front wall or gate. The rear wall plate is adhered and/or secured preferably to a wall or other like stable structure. The front wall or gate is hingedly attached to a lip or protrusion that is formed at the juncture between the base of the enclosure and the front wall or gate frame's lower and inferior edge via a securing mechanism (moveable joint) allowing for movement of linked base and framed front wall. The upper end of the framed ‘front’ wall or gate is releasably fixed to the fixed rear wall plate via a guide cleat mechanism consisting of two to a plurality of attachment points (i.e., cleats). In a closed and secured position, a reversibly releasable rope, cord or wire is affixed or fixed to attachment points thereby fixing and securing the movable framed front wall or gate to said fixed rear wall plate wherein both the fixed rear wall plate and framed front wall or gate are largely parallel (i.e., plus or minus 10 to 15 degrees). When the front wall or gate is released, by unsecuring or releasing the cord or wire from around or through the cleat, the front wall or gate is opened or allowed to open away (and down) from the fixed rear wall plate and the supporting wall at an angle in the range of 0 to 90 degrees, 0 degree is where the front wall or gate is parallel to the rear wall plate and 90 degrees is where the front wall or gate is perpendicular to the rear wall plate. In one embodiment, the front wall or gate is at an angle of 40 degrees from the rear wall plate. When unsecured or released, the tip of the lower end of the angled front wall or gate is in line with the inside edge of the lip or protrusion and there is enough space for the animal to enter the enclosure. Once the animal walks in or is guided into the enclosure, the cord or wire may then be secured around (or through) the cleat to restrain or “sandwich” the animal in the enclosure. The fabric or meshed material cover wrapped around or otherwise adhered or attached to the frame of the front wall or gate has openings, which may be of various numbers or sizes, which allow access to the temporarily fixed, entrapped animal by a technician, veterinarian or any other individual performing procedure(s) on the animal.

In a preferred embodiment of the present invention is an enclosure to humanely restrain animal that comprises a rear wall plate secured to an accepting wall or surface wherein the rear wall plate runs substantially coplanar with the surface to which it will be affixed, a base extending from the lower portion of the rear wall plate, perpendicular to said rear wall plate, and projecting away from said rear wall plate and extending upwards to form a lip or protrusion, forming a junction to a jointly actuatable front wall or gate frame, wherein lower end of said front wall or gate frame is hingedly attached to the lip or protrusion at said base of the present invention and releasably fixed to the rear wall plate at its upper end using one to a plurality of guide cleat and securing cord or wire mechanisms. The front wall or gate consists of a framed area or space which is made to accept a material, itself exhibiting a mesh, spaces or gaps for animal access, whereby said movable front plate or gate is releasable from the rear wall plate and rear wall for angulation away from the rear wall plate and rear wall to receive the animal in the enclosure. Once the animal is walked, guided or placed in the enclosure space between said read wall plate and front wall or gate,, said front wall or gate may be closed and secured, via the above-described securing cord or wire and guide cleat mechanism, to allow for temporary humane restraint of the introduced animal. Upon completion of the temporaneous procedure, the guide cleat and securing cord or wire mechanisms may be unsecured, the front wall or gate lowered, and the animal removed from the invention.

The single or plural guide cleat and securing cord or wire mechanisms of the enclosure comprises one to a plurality of guides located on the upper portion of the rear plate that is away from the base. These guides enable smooth movement of a cord or wire that pass through each guide where the cord or wire is used to secure or unsecure the front wall or gate. Additionally, there are plurality of cleats on the upper end of the front wall or gate and directly opposite the guides on the rear plate. These cleats secure the cord or wire that pass through the guides located on the rear wall. Each cleat has a clamp plate underneath which pinches the cord or wire multiple times as it wraps around the clamp plate before routing through the guides and cleats. It is to be understood, however, that the guides may exist on the devices'upper portion of the gate and the cleat may exist on the upper end of the fixed rear plate.

In one embodiment of the preferred enclosure, the cord or wire is a rope, a cable, a bungee cord, a wire, or a combination thereof. In another embodiment of the preferred enclosure, the front wall or gate comprises a plurality of solid, semi-solid or hollow pipes or rails or a combination thereof, joined at the edges to form a frame of the front wall or gate. In yet another embodiment of the preferred enclosure, the pipes, rails or a combination thereof are made of plastic, additive manufacturing extrusion thermoplastics, aluminum, aluminum alloy, stainless-steel, stainless-steel alloy, copper, steel, brass, or a combination thereof. It is also contemplated that the construction of the frame of the front wall or gate and/or rear plate or gate may be achieved through additive manufacturing. In yet another embodiment, the front wall or gate is rigid, semi-rigid, or elastic which may be metal or plastic mesh which is secured or otherwise adhered to the front wall gate frame via one of any snaps, rivets, ties, glue, cords, or a combination thereof. In still yet another embodiment of the preferred enclosure, the front wall or gate has a fabric gate cover that is wrapped around, or is otherwise attached to, the solid, semi-solid or hollow pipes or rails and fastened by plurality of fixtures or adherences (e.g., snap fasteners, ties, clips, or a combination thereof). These fixtures may be made of plastic, metal, wire, or a combination thereof. Examples of snap fasteners include but are not limited to snap buttons, press buttons, press studs, press fasteners, dome fasteners, poppers, or tich buttons or a combination thereof.

In another embodiment of the preferred enclosure, the fabric gate cover has plurality of openings to access different areas or body parts of the animal when restrained in the enclosure. These openings may be of uniform size, non-uniform size, regular, irregular, or a combination of different patterns, shapes, and sizes. Although the openings can have any geometric shape, some examples of the shape of these openings include circular, square, rectangular, oval, triangular, or a combination thereof. In yet another embodiment of the preferred enclosure, the fabric gate cover is made of material that is elastic, non-elastic, or a combination of elastic and non-elastic, which is pliable, durable, versatile, water, abrasion resistant and strong enough to cradle the animal safely. An example of the material includes but is not limited to 1050 Denier coated ballistic nylon. In yet another embodiment of the preferred enclosure, the animal to be restrained in the enclosure is of small, medium, large or extra-large sizes.

In another preferred embodiment of the present invention is a method of restraining an animal in an enclosure prior to conducting a procedure on the animal. This method comprises bringing the animal close to the enclosure, where the enclosure comprises a rear plate running coplanar with the surface to which the rear plate is affixed to (i.e., a wall), where the rear plate has one to a plurality of guides on its upper portion that is away from the base to allow smooth movement of a cord or wire through each of the guide while securing and unsecuring the cord or the wire, a base extending from the lower portion of the rear plate and projecting away from the rear wall and upwards to form a lip or protrusion, and the front wall or the gate hingedly attached to the lip or protrusion of the base at the lower end and having one to a plurality of cleats on the upper end of the front wall or gate and opposite from the guides on the rear wall, wherein the front wall or gate is releasably fixed to the rear plate at the upper end via a guide cleat mechanism. Once the animal is brought sufficiently close to the enclosure, the cord or a wire around each cleat located on front wall or gate of the enclosure is unsecured to release the front wall or gate of the enclosure away from the rear wall plate and supportive surface, and lowered at an angle adequate to receive the animal in the enclosure. Once the front wall or gate is released, the animal is guided or placed into the enclosure space created between the rear wall plate and the angulated front wall or gate. Once the animal is received by the invention, the cord or the wire is secured around or within the cleat and the cord or wire is tightened so as to bring the front wall or gate into parallel configuration with the rear wall plate and supportive surface, and adjusting pressure on the animal by tightening and loosening the cord or wire within the cleat as to accommodate specific animal height and width parameters, thereby comfortably and humanely restraining the animal in the enclosure. The enclosure also comprises a clamp plate underneath each cleat, where the clamp plate pinches the cord or wire multiple times as the dead end of the cord or wire wraps around the clamp plate before routing through the guides and the cleats.

In another embodiment of the preferred method, the cord or wire is a rope, a cable, a bungee rope, a wire or a combination thereof. In yet another embodiment of the preferred method, the front wall or gate comprises plurality of solid, semi-solid, hollow pipes or rails or a combination thereof joined at the edges to form frame of the front wall or gate. In still yet another embodiment of the preferred method, the pipes or rails are made of additive manufacturing extrusion materials (ex. metals and thermoplastics, including, but not exclusive of butadiene styrene (ABS), aliphatic polyamides (PA), high-impact polystyrene (HIPS), polylactic acid (PLA), and thermoplastic polyurethane (TPU)), plastic, aluminum, aluminum alloy, stainless-steel, stainless-steel alloy, copper, steel, brass, or a combination thereof. It is also contemplated that the construction of the frame of the rear plate or gate may be of a solid, semi-solid or hollow construction achieved through additive manufacturing. In still yet another embodiment of the preferred method, the front wall or gate has a fabric gate cover material that is wrapped around the hollow pipes, or is otherwise adhered to the front gate frame, and fastened by plurality of fasteners (e.g., snap fasteners), rivets, ties, glue, cords, or a combination thereof. These snap fasteners may be made of plastic or metal. It is further understood that the gate cover material may be integrated within the front gate frame or otherwise around the gate frame and adhered to itself. Examples of snap fasteners include but are not limited to snap buttons, press buttons, press studs, press fasteners, dome fasteners, poppers, or tich buttons or a combination thereof.

In another embodiment of the preferred method, the fabric gate cover has plurality of openings to access different areas or body parts of the animal when restrained in the enclosure. These openings may be of uniform size, non-uniform size, regular, irregular, or a combination of different sizes. Although the openings can have any geometric shape, some examples of the shape of these openings include circular, square, rectangular, oval, triangular, or a combination thereof. In yet another embodiment of the preferred method, the fabric gate cover is made of material that is elastic, non-elastic, or a combination of elastic and non-elastic, which is pliable, durable, versatile, water and abrasion resistant and strong enough to cradle the animal safely. An example of the material includes but is not limited to 1050 Denier coated ballistic nylon. In yet another embodiment of the preferred method, the animal that can be restrained in the enclosure is of small, medium, large or extra-large size.

### BRIEF DESCRIPTION OF THE DRAWINGS

So that the manner in which the present invention can be better understood, certain illustrations, charts and/or flow charts are appended hereto. It is to be noted, however, that the drawings illustrate only selected embodiments of the inventions and are therefore not to be considered limiting of scope, for the inventions can admit to other equally effective embodiments and applications.

Moreover, advantages and other aspects of the invention will be readily appreciated by those persons having skill in the art and may be better understood with further reference to the accompanying drawings in which like reference characters designate like or similar elements throughout the several figures of the drawings and wherein:

FIG. 1 illustrates view of the animal restraint in closed confirmation. FIG. 1A is an exploded view of the guide cleat mechanism of the animal restraint. FIG. 1B is an exploded view of the attachment in the lower end of the animal restraint.

FIG. 2 illustrates view of the animal restraint from the top.

FIG. 3 illustrates lateral view of the animal restraint.

FIG. 4 illustrates view of the animal restraint in open confirmation.

FIGS. 5A and 5B illustrate the angles of the fabric gate of the animal restraint in the open and closed confirmations, respectively.

FIG. 6 illustrates the fabric cover of the animal restraint.

However, it should be understood that the above described figures are not intended to be limited to only the invention illustrated and to the particular embodiments disclosed, but on the contrary, the intention is intended to disclose all modifications, alternatives and equivalents falling within the spirit and scope of the invention as defined within the claim's broadest reasonable interpretation consistent with the specification. To wit, variations in height, length, width made be accomplished as to accommodate variances in sizes of animals being restrained, as may be necessary or required.

### DETAILED DESCRIPTION OF THE PREFERRED EMBODIMENTS

A detailed description of the preferred embodiments of the invention is disclosed and described below. Yet, each and every possible feature, within the limits of the specification, are not disclosed as various iterations are postulated to be in the purview and contemplation of those having skill in the art. It is therefore possible for those that have requisite skill in the art to make and practice the disclosed invention while observing that certain features and spatial arrangements are relative and capable of being scaled, adapted, arranged at various points about the present invention (by inventor, manufacturer or both) that nonetheless accomplishes the remediation of one or more of the infirmities as outlined and discussed above in the field of animal restrain device design and use. As well, individual components of the present invention may be sized (i.e. enlarged or shrunken) so long as the proportions are maintained that allow for maintaining of esthetic appearance and proper functioning of the present invention that may be sized and shaped according to a particular procedure and/or the size of the animal to be restrained.

Equally, it should be observed that the present invention can be understood, in terms of structure, function, or both, from the present disclosure as well as those appended claims taken in context with the associated drawings. And whereas the present invention and method of use are capable of several different embodiments and permutations, which can be modified into several different configurations, each exhibiting accompanying interchangeable functionalities, without departing from the scope and spirit of the present application as shown and described.

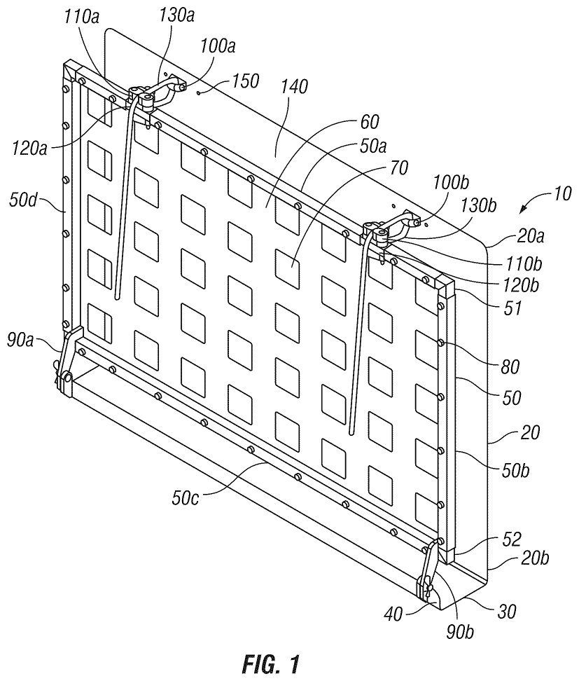

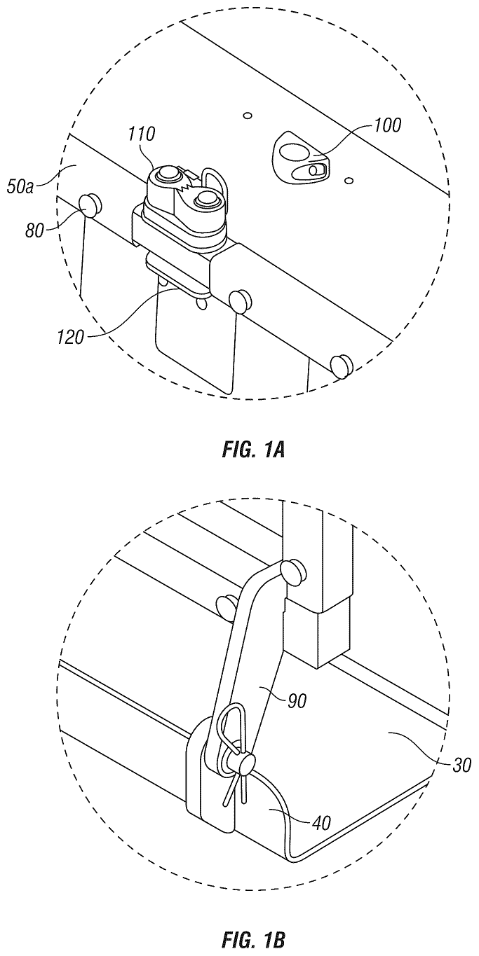

As detailed in FIG. 1, the present invention that is an enclosure 10 to humanely restrain animals of varied sizes including small to medium, large, or extra-large animals, which is presented in closed confirmation, comprises a rear wall plate 20 that runs coplanar with the surface (for e.g. a wall or a partition or any surface that is firm or steady) to which it will be affixed. The rear plate 20 can be affixed to the surface (not shown) by a plurality of nails, glue or screws, or any other means, that allows plate 20 to be fixed firmly to the supportive surface. Additionally, the material of the rear wall plate 20 includes but are not limited to plastics, composites, metals (ex. aluminum, aluminum alloy, stainless-steel, stainless-steel alloy, copper, steel, brass), or a combination thereof. The enclosure 10 also comprises a base 30 that extends from the lower portion 20b of the rear wall plate 20 and projects away from the rear wall 20 to form a lip or protrusion 40. As it pertains to this invention, the lip or protrusion 40 is defined as a raised edge, made to run perpendicular to said base 30, along the base 30 of enclosure 10 most closely related to the hingedly affixable front gate 50. The width and the length of base 30 is sized to accommodate the size of the animal to be restrained which is modifiable based on animal size, particularly width and height.

The enclosure 10 also comprises said front wall or gate 50, which comprises upper end 51 and lower end 52. The frame of front wall or gate 50 comprises a plurality of hollow or solid pipes 50a, 50b, 50c, and 50d (hereafter referred to as frame top 50a, frame side 50b, frame bottom 50c, and frame side 50d, respectively) joined at edges to form a quadrilateral. As shown in FIG. 1, frame 50a is located at the upper end 51 of front wall or gate 50 and frame 50c is located at lower end 52 of front wall or gate 50. One side connecting upper end 51 and lower end 52 is frame 50b and the other side connecting upper end 51 and lower end 52 is frame side 50d. Examples of the material of these pipes or rails, which may be hollow, semi-solid, or solid, include but are not limited to plastics, composites, aluminum, aluminum alloy, stainless steel, stainless-steel alloy, copper, steel, brass, or a combination thereof. Although the frame top and bottom, 50a and 50c and frame sides 50b and 50d in FIG. 1 are of the same length, it is understood that one of skill in the art can alter the length of the frame top and bottom 50a, 50c and frame sides 50b, 50d, the material of the pipes, and the shape of the gate based on their preference as long as it does not significantly alter the functionality of the front wall or gate 50.

The front wall or gate 50 is hingedly attached at its lower end 52 to lip or protrusion 40. The hinges 90a and 90b (collectively, referred to as “hinges 90”) are located at the right hand side and left hand side of frame 50c in lower end 52 and hinges 90 attached front wall or gate 50 to the lip or protrusion 40 as shown in the exploded view in FIG. 1B. However, any number of hinges, including a single mating hinge running the length or a majority of the length of bottom 50c, may be utilized as necessity dictates. The front wall or gate 50 is releasably fixed to the rear wall plate 20 at the upper end 51 of the front wall or gate 50 by means of a guide cleat mechanism or a similar mechanism allowing for the reversable mating of rear wall plate 20 with front wall or gate 50. An example of the placement of the guides, cleats, and clamps of the guide cleat mechanism is further elaborated here and within FIG. 1. However, it is understood that one of skill in the art may alter the positions or substitute components as long as it allows smooth movement of the cord or wire, reversable securement of an animal opening of the enclosure at an angle to receive the animal in the enclosure and closing of the enclosure that is the present invention. As shown in FIG. 1, a plurality of guides 100a and 100b (collectively, referred to as “guides 100”) are located on the top portion 20a of the rear wall plate 20. The guides 100 allow smooth movement of a cord or wire 130a and 130b (collectively referred to as “cords or wires 130”) through guide 100a and 100b, respectively. Frame 50a in upper end 51 of front wall or gate 50 has plurality of cleats 110a and 110b (collectively, referred to as “cleats 110”). The cleats 110 are opposite from the guide 100, and on opposing surfaces front gate 50 and rear wall plate 20, respectively, and secures cords or wires 130 that passes through guide 100. It is to be further understood that the position of the cleats 110 and guides 100 may be reversed wherein each occupies the opposite surface. Underneath cleats 110a and 110b are clamp plates 120a and 120b, respectively (collectively, referred to as “clamp plates 120”). The dead end of the cord or wire 130 wraps around the clamp plate 120 and the clamp plate 120 pinches the cords or wires 130, by pulling outward and/or downward on the cords or wires 130, multiple times before routing through the guide 100 and the cleat 110. Securement may be lessened by applying a pulling force on said front gate 50 as to provide adequate for an enclosed animal. These activities may be used to reverse the effect of each action wherein tightening and loosing of restraints is thereby accomplished. Examples of cord or wire 130 include but are not limited to a rope, a cable, a bungee rope, a wire, or a combination thereof.

Wrapped around the frame top, bottom and side 50a, 50b, 50c, and 50d is a fabric gate cover 60. As depicted in FIG. 1, there are plurality of rivets or snap fasteners 80a, 80b, 80c, . . . (collectively referred to as “snap fastener 80”) along the length of the fabric gate cover 60. The fabric gate cover 60 is wrapped in such a way that the snap fastener 80 is on the outside of front wall or gate 50 and not in the inside of the enclosed area where the animal will be restrained. Additionally, the fabric gate cover 60 does not over the edges of the frame of front wall or gate 50 as shown in FIG. 1. The snap fastener 80 is made of metal or plastic. Examples of types of fastener 80 which may be employed include but are not limited to rivets, snap buttons, press buttons, press studs, press fasteners, dome fasteners, poppers, or tich buttons or similar fasteners. Equally, any manner of tie, cord, zipper, bolt and nut, glue, or a combination thereof, including adherence to the fabric itself, may be utilized to accomplish adherence and securement of fabric gate cover 60 to front gate 50.

As seen in FIGS. 1, 2, 3, 4 and 6, the fabric gate cover comprises multiple openings 70a, 70b, 70c, . . . (collectively referred to as “openings 70”) to access different areas or parts of the body of the animal restrained in the enclosure during a procedure. Examples where this enclosure 10 can be used include but are not limited to exams, short procedures, grooming, nail trims, anal gland expression, blood draw, microchipping, injections, or ear cleaning/treatment. The number, the size and shape of the openings may vary. Examples of shape include but are not limited to circular, square, rectangular, oval, triangular, or a combination thereof. The fabric gate cover 60 may have openings that are of uniform shape and size as shown in FIG. 6. Alternatively, the fabric gate cover may have openings, uniform, randomly placed, regular or irregular, that are a combination of different shapes and sizes. The fabric gate cover 60 is made of material that is that is pliable, elastic, durable, versatile, water and abrasion resistant and strong enough to cradle the animal safely when it is restrained in enclosure 10. Alternatively, the gate cover may be non-fabric and consist of a metal mesh or non-elastic (or semi-rigid) plastic so long as the objectives of animal securement and effectiveness in accomplishing the above tasks is accomplishable or accomplished. One example of such material includes but is not limited to 1050 Denier coated ballistic nylon.

FIG. 1A is an exploded view of the guide cleat mechanism that releasably connects top portion 20a of rear wall plate 20 and front frame top 50a located in upper end 51 of front wall or gate 50.

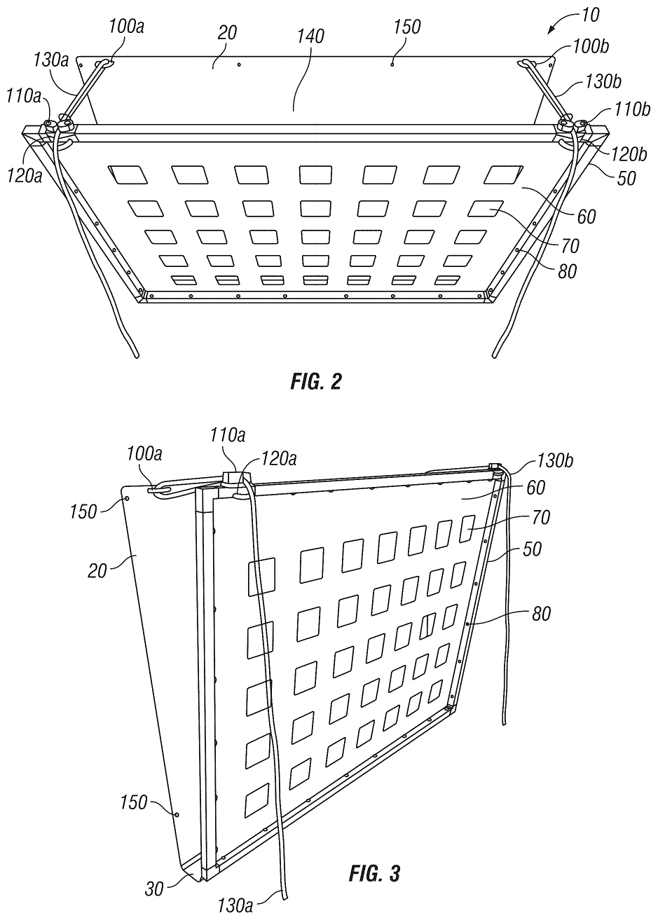

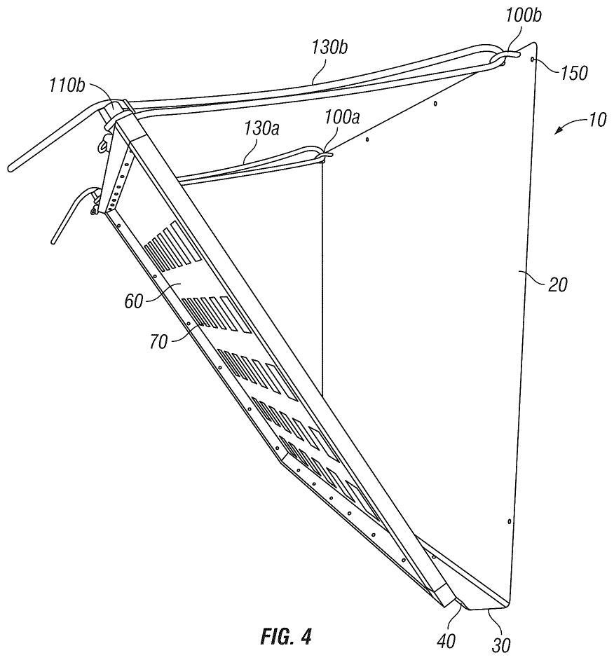

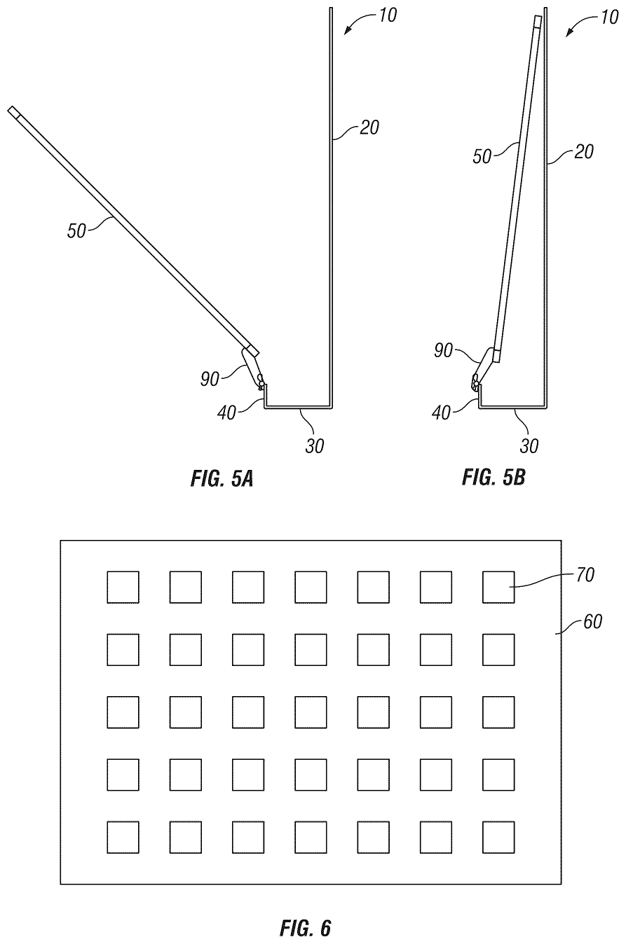

When enclosure 10 in closed, confirmation is viewed from top as shown in FIG. 2 or laterally as shown in FIG. 3, one can see space 140 between rear wall plate 20 and front wall or gate 50 where the restrained animal will be situated. Base 30 of enclosure 10 provides support for the animal to stand on when it walks into or is guided into enclosure 10 and is thereafter restrained. Operationally, the front wall or gate 50 is opened by unsecuring the cord or wire 130 from around cleat 110 so that the cord or wire 130 moves smoothly around guide 100. This causes front wall or gate 50 to open at an angle, guided by gravity, as shown in FIGS. 4 and 5A, which creates space 140 for the animal to walk in or be placed in the enclosure 10. Once the animal is within the confines of the enclosure 10 and stands on base 30, the dead end of cord or wire 130 is pulled and cord or wire 130 is secured around cleat 110 and front wall or gate 50 closes at an angle shown in FIG. 5B. The animal is now securedly confined within device 10 and the scheduled procedure may occur.

Adjustment of the device 10 is accomplished by tightening and loosening the cord/cleat mechanism (described supra) as to adjust the size and pressure of device 10 as to accommodate various sized animals and to tailor and customize device 10 as to adapt to each specific animal, regardless of shape or size.

After completing of the procedure, the operation may be reversed whereby cord or wire 130 is loosened and released from cleat 110, front gate 50 is drawn away from rear wall plate 20, front gate 50 is angled downward and the retrained animal is removable from the enclosure 10.

Although only a select few example embodiments have been described in detail above, those skilled in the art will readily appreciate that many modifications are possible in the example embodiments without materially departing from this disclosure of the invention. Accordingly, all such modifications are intended to be included within the scope of this disclosure as defined in the appended claims.

1. An enclosure to humanely restrain an animal, comprising:
a rear wall plate running substantially coplanar with a surface to which the rear wall plate will be affixed; a base extending from the lower portion of the rear wall plate, perpendicular to the rear wall plate, and projecting away from the rear wall plate and upwards to form a lip or protrusion, forming a junction to a jointly actuatable front wall or gate; and a lower end of the front wall or gate hingedly attached to the lip or protrusion at the base and releasably fixed to the rear wall plate at the upper end using one or more guide-cleat and securing cord or wire mechanisms, wherein said front wall or gate is releasable from the rear wall plate for angulation away from the rear wall to receive the animal in the enclosure, securable to the rear wall plate once the animal has entered the enclosure, and adjustable based on animal size and dimensions.

2. The enclosure of claim 1, wherein the guide-cleat and securing cord or wire mechanism comprises:
one or more guides located on the upper portion of the rear wall plate away from the base;
each guide enabling smooth movement of a cord or wire used to secure or unsecure the front wall or gate; one or more cleats located on the upper end of the front wall or gate and directly opposite the guide or guides; and a clamp plate underneath each cleat, wherein the clamp plate pinches the cord or wire as it wraps around the clamp plate before routing through the guides and cleats.

3. The enclosure of claim 2, wherein the cord or wire is a rope, a cable, a bungee cord, a wire, or a combination thereof.

4. The enclosure of claim 1, wherein the front wall or gate comprises a plurality of solid, semi-solid, or hollow pipes or rails, or a combination thereof, joined at the edges to form a frame.

5. The enclosure of claim 4, wherein the pipes or rails are made of plastic, additive manufacturing extrusion thermoplastics, aluminum, aluminum alloy, stainless steel, stainless-steel alloy, copper, steel, brass, or a combination thereof.

6. The enclosure of claim 4, wherein the front wall or gate comprises metal or plastic mesh secured or adhered to the gate frame via snaps, rivets, ties, glue, cords, or a combination thereof.

7. The enclosure of claim 4, wherein the front wall or gate comprises a fabric gate cover wrapped around or otherwise attached to the frame and fastened by a plurality of snap fasteners, rivets, ties, glue, cords, or a combination thereof.

8. The enclosure of claim 7, wherein the snap fasteners are made of plastic or metal and are selected from snap buttons, press buttons, press studs, press fasteners, dome fasteners, poppers, or tich buttons, or a combination thereof.

9. The enclosure of claim 7, wherein the fabric gate cover comprises a plurality of openings to access different areas or parts of the animal when restrained, the openings being of uniform size, non-uniform size, regular, irregular, or a combination thereof.

10. The enclosure of claim 9, wherein the openings are circular, square, rectangular, oval, triangular, or a combination thereof.

11. The enclosure of claim 7, wherein the fabric gate cover is made of elastic, non-elastic, or a combination of elastic and non-elastic material that is pliable, durable, versatile, water-and abrasion-resistant, and strong enough to cradle the animal safely, the material comprising 1050 Denier coated ballistic nylon.

12. The enclosure of claim 1, wherein the animal is of small, medium, large, or extra-large size.

13. A method of restraining an animal in an enclosure prior to a procedure, comprising:
bringing the animal close to the enclosure comprising a rear wall plate affixed to a surface, the rear wall plate having one or more guides on its upper portion;
a base extending from the lower portion of the rear wall plate and projecting away and upwards to form a lip or protrusion; a front wall or gate hingedly attached to the lip or protrusion and having one or more cleats opposite the guides; unsecuring a cord or wire from each cleat to release and lower the front wall or gate at an angle to receive the animal; introducing or guiding the animal into the space between the rear wall plate and the lowered front wall or gate; securing the cord or wire around the cleat to close the front wall or gate; and adjusting pressure on the animal by tightening or loosening the cord or wire within the cleat to accommodate animal height and width parameters.

14. The method of claim 13, wherein the enclosure comprises a clamp plate underneath each cleat, the clamp plate pinching the cord or wire multiple times as the end of the cord or wire wraps around the clamp plate.

15. The method of claim 13, wherein the cord or wire is a rope, a cable, a bungee rope, a wire, or a combination thereof.

16. The method of claim 13, wherein the front wall or gate comprises a plurality of solid, semi-solid, or hollow pipes or rails, or a combination thereof.

17. The method of claim 16, wherein the pipes or rails are made of additive-manufactured thermoplastic, plastic, aluminum, aluminum alloy, stainless steel, stainless-steel alloy, copper, steel, brass, or a combination thereof.

18. The method of claim 13, wherein the front wall or gate comprises a fabric gate cover wrapped around or adhered to the frame and fastened by a plurality of fasteners, rivets, ties, glue, cords, or a combination thereof.

19. The method of claim 18, wherein the fasteners are snap fasteners made of plastic or metal comprising snap buttons, press buttons, press studs, press fasteners, dome fasteners, poppers, or tich buttons, or a combination thereof.

20. The method of claim 18, wherein the fabric gate cover comprises a plurality of openings to access different areas or parts of the animal.

21. The method of claim 20, wherein the openings are circular, square, rectangular, oval, triangular, or a combination thereof.

22. The method of claim 18, wherein the fabric gate cover is made of elastic, non-elastic, or combined elastic and non-elastic material that is pliable, durable, versatile, water-and abrasion-resistant, and strong enough to cradle the animal safely, the material comprising 1050 Denier coated ballistic nylon.

23. The method of claim 14, wherein the animal is of small, medium, large, or extra-large size.
